(19) United States
(12) Patent Application Publication
(10) Pub. No.: US 2010/0140181 A1
(43) Pub. Date: Jun. 10, 2010

(54) REGENERATION OF USED CLEANING SOLUTION

(76) Inventor: Gilles TASTAYRE, Burlington (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 12/328,794

(22) Filed: Dec. 5, 2008

(51) Int. Cl. C02F 1/52; B01D 35/30

(52) U.S. Cl. 210/728; 210/205

(57) ABSTRACT

A process is provided for improving the precipitation of calcium and/or magnesium salts in the regeneration of used alkaline cleaning solution. The process includes the steps of providing a spent alkaline or acidic cleaning solution; adding sodium bentonite and sodium carbonate to the spent alkaline or acidic cleaning solution in a mixing zone to provide an interactive solution; adding either an anionic polymeric flocculating agent or a cationic polymeric flocculating agent to interactive solution, thereby precipitating insoluble calcium and magnesium salts as flocs; and subjecting the solution containing such flocs to a filtration process to bring the precipitated solids to a solids contents of >25%.

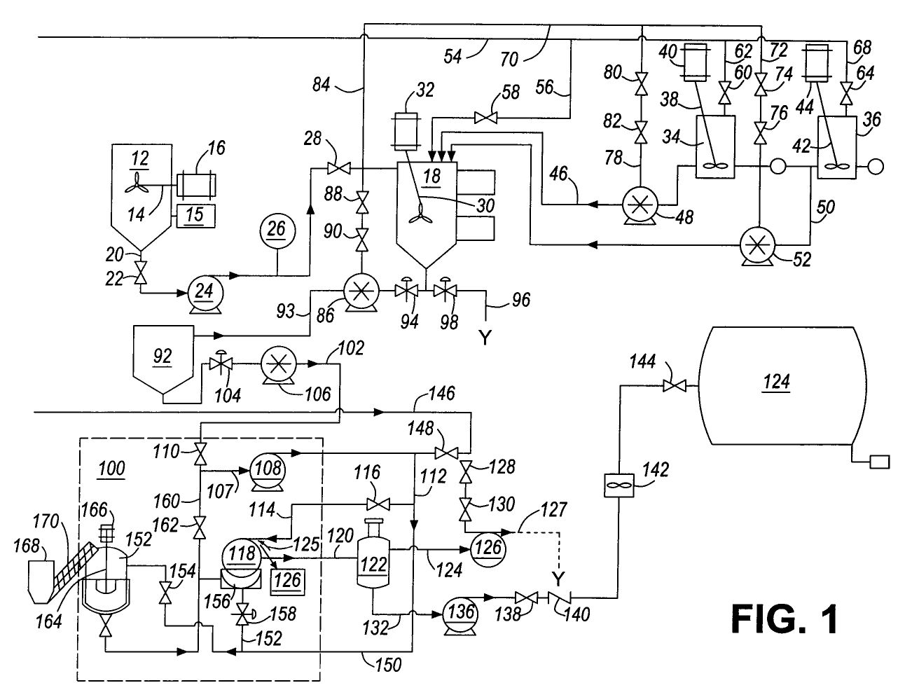

### BACKGROUND OF THE INVENTION

(a) Field of the Invention

This invention relates to improving the precipitation of calcium and magnesium ions in the regeneration of used alkaline or acidic cleaning solutions.

(b) Description of the Prior Art

It is known to clean and clarify water by adding one or more coagulating agents to water to combine fine particles therein into flocs and thereby to sediment the flocs by gravity. In this known method, water is separated into a floc phase and an aqueous phase. The thus separated flocs are removed from the treating vessel and are dewatered, i.e., dehydrated, and the solids discarded. The separated water is finally returned to rivers.

It is also well known that metal ions dissolved in water can be removed by the addition of various treatment agents which react with the metal ions and precipitate them as insoluble salts. This is of use in the treatment of contaminated water when, for example, the addition of calcium hydroxide (lime) to hard water will cause the precipitation of metal carbonates and so remove the metal and bicarbonate ions from the water. This precipitation process can be further improved by the addition to the water of a polyelectrolyte which promotes the flocculation of the solid particles and a weighting agent, e.g., calcium carbonate, which increases the specific gravity of the flocculated matter and therefore increases the rate of sedimentation and thus the rate of clarification of the liquor.

It is also known to remove suspended solid materials from water by the addition of coagulants, e.g, aluminum sulfate, iron chloride, etc., which are normally employed along with lime in conjunction with sedimentation and/or filtration procedures. The coagulants, and frequently a coagulant aid, assist the building of a floc to a proper size for settling; sedimentation units permit the separation of the relatively slow settling floc thus formed from the purified water.

The patent literature also purports to be directed to the problem of purifying of solutions.

British Patent No. 2,095,226 describes a composition which is said to be of use in the purification of water and which contains an alkaline earth metal hydroxide and an anionic oligomeric polyelectrolyte, and which may additionally contain a weighting agent and a cationic polyelectrolyte.

British Patent No. 2,157,278 describe a method of treating water using a composition containing calcium sulphate as a weighting agent, an electrolyte having a multivalent cation, e.g., iron (III) or aluminum and a cationic or anionic polyelectrolyte. In such patent, the specific polyelectrolyte used as cationic.

Canadian Patent No. 2,006,512 patented Dec. 22, 1989 by A. Timmons provided a method for the purification of contaminated water. The treatment involved the application to the water of anionic and cationic coagulants at different stages. Between the application of the coagulants, precipitation agents were added to precipitate the contaminants which typically were metal ions in solution. The coagulants were polyelectrolytes. It was taught that the first added coagulant caused formation of a floc and the addition of the second coagulant caused heavy deposition of contaminants. Separation followed and the separated solids were passed to a sludge thickening tank, while the separated liquid could be filtered to provide clean water which could be returned to a stream or river.

Canadian Patent No. 2,012,201 patented Mar. 14, 1990 by S. D. Kamato et al, provided a method for treating water which included adding a first chemical containing an alkali metal or alkaline earth metal oxide or hydroxide to the water to be treated, thereby rendering muddy water alkaline. A second chemical containing an anionic polymer coagulant was added to the water, either simultaneously with, or after, the addition of the first chemical. A third chemical containing a sulfate was the added, thereby rendering the water weakly alkaline. Finally, a fourth chemical containing an anionic polymer coagulant was added to the muddy water. As a result, large-sized and hard flocs were produced. When the water was in the weakly alkaline state, an anionic polymer coagulant was added to the muddy water to cause remaining fine particles, the hydroxide and the metal ions to be combined, resulting in larger-sized and harder flocs.

U.S. Pat. No. 5,510,037 patented Apr. 23, 1996, by Gilles Tastayre provided a process for regenerating spent cleaning solutions. The process involves the sequential steps of first preconditioning the spent solution. Then, an absorbent material is added to the preconditioned solution to provide an interactive solution. Suitable precipitation agents are added to the interactive solutions to precipitate undesirable materials from the solutions. The precipitating of the undesirable materials from the interactive solution is accomplished by adding an anionic and a cationic polymeric flocculating agent thereto, in the sequence of steps (i) adding one of the anionic or cationic polymeric flocculating agent to the interactive solution to provide a reactive solution, (ii) thoroughly mixing the reactive solution, and (iii) adding the other of the anionic or cationic flocculating agent, thereby precipitating insoluble salts as floes. Finally, the solution containing the precipitated flocs is subjected to a solid/liquid separation.

Because cleaning is a complex technology whose efficacy is governed by four parameters, namely time, temperature, concentration, and shear. Some cleaning solutions contain detergents to remove soils, and/or compounded alkalis and caustics to react upon organic residues. Other such cleaning solutions may contain acids to remove inorganics and minerals.

### SUMMARY OF THE INVENTION

(a) Aims of the Invention

In spite of these teachings, there is still a need for further improvements, and in particular there is a need for the regeneration of used such alkaline cleaning solutions.

Accordingly, it is an object of the present invention to provide a method for the regeneration of spent alkaline and acidic cleaning solutions which is simple to operate, and provides effective flocculation of solid calcium and/or magnesium salts which are precipitated when chemical treatment agents are added to the solution.

It is another object of the present invention to provide a method for regenerating spent alkaline and acidic cleaning solutions wherein large-sized and hard flocs can be formed by the use of small amounts of chemicals.

Another object of this invention is to provide a process for regenerating spent alkaline and acidic cleaning solutions wherein dispersed residues, which have been removed from dirty surfaces are removed so that the residues to not react with caustic, which would thus tend to reduce cleaning efficacy, and so that available active caustic concentration remains higher with less top-over needed to maintain concentration.

Yet another object of this invention is to provide a process for regenerating spent alkaline and acidic cleaning solutions wherein the soil load is kept at low level, so that such cleaning solutions are more active and clean faster.

Still another object of this invention is to provide a process for regenerating spent alkaline and acidic cleaning solutions in which organic soil, which has low heat transmittance and tends to foul heating surfaces, is removed so that the regenerated solutions may be heated while using less energy and while not fouling surfaces.

A still further object of this invention is to provide a process for regenerating spent alkaline and acidic cleaning solutions in which soiled solutions which have higher viscosity that impair soil penetration and removal are treated to remove the soil so that regenerated solutions flow better and penetrate more efficiently.

(b) Statement of Invention

The present invention is based on the use of sodium bentonite with up to a predetermined amount of sodium carbonate to improve the precipitation of calcium and magnesium from alkaline solutions in conjunction with the use of either an anionic polymeric flocculating agent or a cationic polymer flocculating agent at any ambient temperature.

Thus, the present invention provides a process for regenerating spent alkaline and acidic cleaning solutions comprising the steps of: providing a spent alkaline or acidic cleaning solution; adding sodium bentonite and sodium carbonate to the spent alkaline or acidic cleaning in a mixing zone solution to provide an interactive solution; adding either an anionic polymeric flocculating agent, or a cationic polymeric flocculating agent to the interactive solution, thereby precipitating insoluble calcium and magnesium salts therefrom as floes; and subjecting the interactive solution containing such flocs to a filtration process to bring the precipitated solids to a solids contents of >25%.

(c) Other Features of the Invention

A preferred sodium bentonite which is used is the Wyoming or Black Hills type of swelling bentonite. This type of bentonite is composed almost entirely of particles of montmorillonite that expand or swell greatly when dispersed in water.

The Wyoming or Black Hills type bentonite is in the form of colloidal particles which are typically hydrophilic in character. That is, each particles is hydrated or solvated, and made bulky and loose-textured by firmly bound water which penetrates between, and expands greatly, the lattice sheets making up each unit of a bentonite particle. The bound water also forms a thick seat which encloses each unit.

Sodium bentonite possesses the following characteristics which relate more specifically to the practice of the present invention. When suspended in water which contains unsubstantial quantities of electrolytes or ionizable substances, sodium bentonite swells to as much as thirty times its original volume to form a gelatinous paste which, upon further dilution with water, if need, can be dispersed by stirring to form a colloidal sol. In this sol the disperse phase comprises negatively charged, highly hydrated bentonite particles of the type hereinabove described. In the absence of some suitable flocculating agent such a sol will show no separation of the disperse phase for an indefinite period of time due to the mutual repulsion of the outer, cationic portion of the cations being carried by the “bound” water surrounding each bentonite particle. If however, an electrolyte, or ionizable material capable of furnishing cations, be added in suitable proportion to such a bentonite sol, there ensues a sufficient neutralization of the anions, the anions being carried by the bentonite particles themselves, and concomitant reduction in their mutual repulsion, so that groups of the particles coalesce to form aggregates of varying sizes. In the case of a majority of the bentonite particles, his aggregation extends until there is a rapid formation of visible flocs. The sodium bentonite must be used in conjunction with sodium carbonate to precipitate excess magnesium and/or calcium tons.

In the precipitation or flocculation step, it is necessary to make use of polymeric flocculating agents.

Anionic polymer coagulants which may be used singly or in combination include, for example, alginic acid, alginates, e.g., sodium alginate, sodium polyacrylate, maleate, copolymers, and partial hydrolyzates of polyacrylamide, anionic polyacids and salts thereof and may be, e.g., an alkali metal salt of a simple or complex oligomer of acrylic or methacrylic acid, low-viscosity, sodium carboxymethylcellulose or an oligomeric sulphonate. In neutral or acid solution, chitosan may also be used.

The cationic coagulant may be a polyamide or a polyacrylate.

In carrying out such precipitation step, the selected coagulant (e.g., the anionic coagulant or the cationic coagulant) is added to the interactive solution. Such solution is then thoroughly mixed.

The final solids/liquids separation step is achieved by filtration using, e.g., carbon sand, a membrane or a stainless steel membrane. Conventional filter sands may also be used. A preferred technique is the use of a rotary vacuum filter with an appropriate precoat thereon. Filtration is in the range of 1 to 10 microns. This does not preclude the use of other filtration technique provided the right solids contents is obtained. At this concentration, the residue may be disposed off as regular solid waste and no specific disposal method is required.

The process may or not include ultrafiltration of the filtered solution as a final step further to increase the clarity of the treated solution and to insure substantially complete removal of any potential micro-organism therein. Such ultrafiltration is done at 5000 to 15000 Dalton cutoff point with appropriate membranes.

The filtration may also include an oxidation step. Ozone, hydrogen peroxides or other appropriate chemical oxidizers may be added to complete the oxidation of any further impurities in the solution.

Filtering may also be achieved through structures containing much coarser sand acting largely as straining devices, (known as “rapid sand filters”). It is to be appreciated that filters have little inherent clarifying capacity of themselves and the basis for clarification has been provided by prior treatment appropriate chemicals as above described. That is the suspended matter therein is treated to collect or coalesce into sufficiently large agglomerates so as to settle out and be substantially removed, (e.g., by primary filtration) in advance of the secondary filtration. Such a process may include absorption by means of active agents by a flocculating polymer, setting in sedimentation basins to remove the agglomerates and finally the primary filter, which takes out the larger sized contaminants.

In order to prevent clogging of the openings and eventually slowing down or completely stopping the flow of liquid through the filter, a small amount of filter aid may be added to the liquid to be filtered.

In order to increase the initial efficiency of the filtering process, a pre-coat of filter aid particles may be provided on the filter in addition to the incorporation of particles within the liquid to be filtered. The materials most generally used as filter aids include diatomacecous silica, perlite, other siliceous material, carbon, and fibrous matter, e.g., cellulose.

Other filter aids involve the step of preconditioning the filter feed by adding thereto small amounts of powdered active magnesium oxide and pulverulent filter aids, earlier described, preferably in a pre-filter tank having mild agitation and normal retention, and then filtering by an standard type of filter aid filter technique.

### BRIEF DESCRIPTION OF THE DRAWING

The accompanying drawing is a schematic drawing of the regeneration system for carrying out the regeneration process of the present invention.

### DESCRIPTION OF A PREFERRED EMBODIMENT OF THE INVENTION

As seen in the single FIGURE of drawings, the regeneration system includes a spent cleaning solution holding tank 12, which is equipped with a stirrer 14, driven by motor 16. Holding tank 12 is provided with level controller 15 to determine the volume of liquid in holding tank 12. Holding tank 12 is connected to mixing tank 18 by way of inflow feed line 20 from the bottom of holding tank 12 which is provided with manual outflow control valve 22, pump 24, which is controlled by a flow switch 26, and inflow air valve 28 to inflow feed line 20 feeding to the top of nixing tank 18. Flow switch 26 controls the operation of pump 24 to stop the operation of pump 24 if there is no liquid in the holding tank 12 and hence in pump 24. The mixing tank 18 is equipped with a stirrer 30 which is driven by motor 32.

The mixing tank 18 is connected to a primary reagent tank 34 and to a secondary reagent tank 36, which are equipped with a primary stirrer 38 which is driven by primary motor 40, and a secondary stirrer 42 which is driven by secondary motor 44, respectively.

Connection between primary reagent tank 34 and mixing tank 18 is by way of primary feed line 46 extending from near the bottom of primary reagent tank 34 to the top of mixing tank 18, a slurry of the primary reagent being pumped by pump 48.

Connection between secondary reagent tank 36 and mixing tank 18 is by way of secondary feed line 50 extending from near the bottom of secondary reagent tank 36 to the top of mixing tank 18, a solution or slurry of the secondary reagent being pumped by pump 52.

The mixing tank 18 is also connected to a first water line 54, via a branch water line 56, which is equipped with a solenoid valve 58 in the branch water line 56 leading to top of the mixing tank 18. The first water line 54 is also provided with a first water pressure regulator valve 60 near the end of a first water pressure line 62 and a second water pressure regulator valve 64 near the end of a second water pressure line 68. First water pressure regulator valve 60 controls the amount of water admitted into primary reagent tank 34 through first water pressure line 62 to be mixed with the first reagent to provide a first reagent slurry. Second water pressure regulator valve 64 controls the amount of water admitted into secondary reagent tank through second water pressure line 68 to be mixed with the second reagent to provide a second reagent solution or slurry.

An air line 70 also is connected as follows: via a first air branch line 72 to pump 52, via suitable valves, namely, solenoid valve 74 and air control valve 76; via a second air branch line 78 to pump 48 via suitable valves, namely solenoid valve 80 and air control valve 82; and via a third air branch line 84 to pump 86 via suitable valves, namely, solenoid valve 88 and air control valve 90. The air control vales 76, 82 and 90 control the respective solenoid valves 74, 80 and 88 to operate the respective pumps 52, 48 and 86.

The mixing tank 18 is connected to a balance tank 92, by withdrawal line 94 which is connected between the bottom of mixing tank 18 and the top of balance tank 92, by way of valve 94 and pump 86. Balance tank 92 is provided to assure continuous flow to the suitable filter system (to be described later) even though the operation of the mixer to provide the precipitate is cyclical. A drain line 96 from the bottom of mixing tank 18 is also controlled by valve 98.

The balance tank 92 is connected to a suitable filter system, in this embodiment being a rotary vacuum filter system indicated generally as 100. The connection between balance tank 92 and the filter system is by way of a first flow line 102 from the bottom of balance tank 92 via air valve 104 and pump 106, then by a second flow line 106 to pump 108 via manual valve 110, then by a third flow line 117 and fourth flow line 114 via manual valve 116 to the inlet side of rotary vacuum filter 118.

Rotary vacuum filter 118 includes a first outlet line 120 which is connected to the inlet of defoamer 122, via vacuum connecting line 124, and a doctor blade to scrape solids to an outlet sludge bin 126. The vacuum connecting line 124 from defoamer 122 is connected to a vacuum pump 126 which exhausts via exhaust line 127. Inlet air to vacuum pump 126 via manual valves 128, 130. Defoamer 122 also includes a major outlet line 132 connected between the bottom of defoamer 122 and the inlet of a major tank 124, via a pump 136, and suitable valves, namely, manual valve 138, check valve 140, flow meter 142 and manual valve 144.

A precoat storage tank 168 is connected to the top of mix tank 152 via upwardly-slanting screw conveyor 170. Mix tank 152 includes a water inlet line 150 connected to third flow line 112, water inlet line 150 leading into mix tank 152 via manual valve 154. Precoat material from precoat sludge tank 168 which is fed into mix tank 152 via slating screw conveyor 170 is mixed to a slurry by means of the added water, and mixer 164 rotated by motor 166.

A slurry withdrawal line 159 leads, via manual valve 160 and line 106 to pump 108 and thence via line 112, and 114 to the top of rotary vacuum filter 118. This forms a filter cake on the rotary vacuum filter 118. Excess slurry is withdrawn via line 157 and manual valve 158 to be recycled to the mix tank 152 via line 150 and manual valve 154.

In use, after the alkaline or acidic cleaning solution is used in a cleaning step, such cleaning solution results in a spent alkaline or spent acidic cleaning solution to be regenerated. The regeneration according to the present invention will now be described.

The spent alkaline or acidic cleaning solution is thoroughly mixed in the spent alkaline or acidic cleaning solution holding tank and is pumped into the mixing tank. The primary reagent tank holds an aqueous slurry of bentonite and sodium carbonate. It is thoroughly mixed and is pumped into the mixing tank. The secondary reagent tank holds an aqueous solution and/or slurry of a flocculating agent, i.e., either an anionic coagulant or a cationic coagulant as previously described. It is thoroughly mixed and is pumped into the mixing tank.

The thorough mixing in the mixing tank of the added reagents to the spent alkaline or acidic cleaning solution improves the precipitation of the calcium and/or magnesium salts.

The thoroughly-mixed precipitated solution from the mixing tank is pumped into the balance tank. The balance tank is never empty so that the filtration process can continue continuously while the spent alkaline or acidic cleaning solution is being cyclically mixed with the bentonite, sodium carbonate and flocculating agent Then the solution with the precipitates therein is pumped to a rotary vacuum filter system. The rotary vacuum filter has previously been provided with a filter aid coating thereon. The solids are scraped off by a doctor blade and deposited to a sludge bin. The withdrawn liquid is defoamed in a defoamer and is pumped to a holding tank for regenerated cleaning solution to be fortified by others.

The regenerated cleaning solution may be subjected to the optional step of chemical make-up by the addition of concentrated chemicals. This, then provides a reusable cleaning solution.

Important advantages of the present invention include the following:

Regenerates and recycles spent alkaline and acidic cleaning solutions.

Maintains alkaline cleaning solutions at peak efficiency.

Significantly reduces chemical, organic, and BOD/COD pollution.

Saves on chemical usage.

Saves on water usage.

Saves on energy.

Reduces cleaning time to increase overall productivity.

Decrease or eliminate the need for waste water treatment facilities.

### CONCLUSION

From the foregoing description, one skilled in the art can easily ascertain the essential characteristics of this invention, and without departing from the spirit and scope thereof, can make various changes and modifications of the invention to adapt it to various usages and conditions. Consequently, such changes and modifications are properly, equitably, and “intended” to be, within the full range of equivalence of the following claims.

I claim:

1. A process for improving the precipitation of calcium and/or magnesium salts in the regeneration of used alkaline or acidic cleaning solution comprising the steps of:
(a) providing alkaline or acidic cleaning solution; (b) adding a thoroughly-mixed aqueous slurry of sodium bentonite and sodium carbonate to the raw, untreated spent alkaline or acidic cleaning solution to provide an interactive solution; (c) adding either an anionic polymeric flocculating agent or a cationic polymeric flocculating agent to said interactive solution, thereby precipitating insoluble calcium and magnesium salts as flocs and simultaneously providing a reactive solution; and (d) subjecting the reactive solution containing such floes to a filtration process to bring the precipitated solids to a solids content of >25%.

2. The process of claim 1 wherein said precipitation of insoluble calcium and magnesium salts in flocs is carried out cyclically, and wherein said filtration is carried out continuously.

3. The process of claim 2 wherein said continuous filtration is achieved by providing a balance zone for said cyclically-produced alkaline or acidic cleaning solution which has been so-treated.

4. The process of claim 1 wherein said sodium bentonite is the Wyoming or Black Hills type of swelling bentonite.

5. The process of claim 1 wherein said flocculating agent is an anionic polymer coagulant which is selected from the group consisting of alginic acid, alginates, e.g., sodium alginate, sodium polyacrylate, maleate, copolymers, and partial hydrolyzates of polyacrylamide, anionic polyacids and salts thereof, an alkali metal salt of a simple or complex oligomer of acrylic or methacrylic acid, a low-viscosity, sodium carboxymethylcellulose and an oligomeric sulphanate.

6. The process of claim 1 wherein said flocculating agent is a cationic coagulant which is selected from the group consisting of a polyamide and a polyacrylate.

7. The process of claim 1 wherein in carrying out said precipitation step, the selected coagulant is added to the interactive solution, and said solution is then thoroughly mixed in a mixing zone.

8. The process of claim 1 wherein said filtration process is carried out using carbon sand, filter sand, a membrane, a stainless steel membrane, or a rotary vacuum filter with an appropriate precoat.

9. The process of claim 8 wherein said filtration is in the range of 1 to 10 microns.

10. The process of claim 8, including a precoat comprises a filter aid which is selected from the group consisting of diatomaceous silica, perlite, other siliceous material, carbon, and fibrous cellulose.

11. The process of claim 1 including the additional steps of ultrafiltration of the filtered solution at 5000 to 15000 Dalton cutoff point with appropriate membranes.

12. The process of claim 1 wherein said filtration includes an oxidation step.

13. The process of claim 12 wherein said oxidation step includes the use of ozone, hydrogen peroxides or other appropriate chemical oxidizer.

14. The process of claim 1 wherein:
wherein said step (b) is carried out using the Wyoming or Black Hills type of swelling sodium bentonite and sodium carbonate;
wherein said step (c) is carried out using an anionic polymer coagulant flocculating agent which is selected from the group consisting of alginic acid, alginates, sodium alginate, sodium polyacrylate, maleate, copolymers, and partial hydrolyzates of polyacrylamide, anionic polyacids and salts thereof, an alkali metal salt of a simple or complex oligomer of acrylic or methacrylic acid, a low-viscosity, sodium carboxymethylcellulose and an oligomeric sulphonate, and wherein, in carrying out said precipitation step (c), the selected coagulant flocculating agent is added to the interactive solution, and said solution is then thoroughly mixed;
wherein said filtration process step (d) is carried out using carbon sand, filter sand, a membrane, a stainless steel membrane, or a rotary vacuum filter with an appropriate precoat, wherein said filtration is in the range of 1 to 10 microns, including the additional steps of ultrafiltration of the filtered solution at 5000 to 15000 Dalton cutoff point with appropriate membranes; and
wherein said filtration step includes an oxidation step.

15. The process of claim 1 wherein:
wherein said step (b) is carried out using the Wyoming or Black Hills type of swelling sodium bentonite and sodium carbonate;
wherein said step (c) is carried out using a cationic coagulant flocculating agent which is selected from the group consisting of a polyamide and a polyacrylate, and wherein, in carrying out said precipitation step (c), the selected coagulant flocculating agent is added to the interactive solution, and said solution is then thoroughly mixed;
wherein said filtration process step (d) is carried out using carbon sand, filter sand, a membrane, a stainless steel membrane, or a rotary vacuum filter with an appropriate precoat, wherein said filtration is in the range of 1 to 10 microns, including the additional steps of ultrafiltration of the filtered solution at 5000 to 15000 Dalton cutoff point with appropriate membranes; and
wherein said filtration includes an oxidation step.

16. A spent cleaning solution regeneration system comprising:
(a) a spent cleaning solution holding tank;
(b) a mixing tank;
(c) a main conduit from said spent cleaning solution holding tank to said mixing tank;
(d) a primary reagent tank;
(e) a primary conduit from said primary reagent tank to said mixing tank;
(f) a secondary reagent tank;
(g) a secondary conduit from said secondary reagent tank to said mixing tank;
(h) a balance tank;
(i) an outflow conduit from said mixing tank to said balance tank;
(j) a filter system;
(k) a filter conduit from said buffer tank to an inlet to said filter system;
(l) a regenerated spent cleaning solution tank; and
(m) a conduit from an outlet from said filter system to said regenerated spent cleaning solution tank.

17. The spent cleaning solution regeneration system of claim 16 wherein
(A) said spent cleaning solution holding tank is provided with a powered stirrer, and/or
(B) said mixing tank is provided with a powered stirrer; and/or
(C) said mixing tank is provided with a first water inlet conduit; and/or
(D) said primary reagent tank is provided with a powered stirrer; and/or
(E) said primary reagent tank is provided with a second inlet conduit, and/or
(F) said secondary reagent tank is provided with a powered stirrer; and/or
(G) said secondary reagent tank is provided with a third water inlet conduit; and/or
(H) said filter system includes
(i) a rotary vacuum filter,
(ii) an inlet from said filter conduit to said rotary vacuum filter,
(iii) a waste outlet from said rotary vacuum filter to a sludge bin,
(iv) a primary outlet from said vacuum filter to a defoamer,
(v) a connection between said defoamer and a vacuum pump, and
(vi) an outlet from said defoamer to said conduit to said regenerated cleaning solution tank; and/or
(I) a precoat system including
(vii) a precoat mix tank,
(viii) a mix tank for a material to be precoated,
(ix) a powered mixer within said my tank; and
(x) a conveyor from said precoat mix tank to said mix tank.
